(19) United States
(12) Patent Application Publication
(10) Pub. No.: US 2025/0372622 A1
(43) Pub. Date: Dec. 4, 2025

(54) SOLID-STATE BATTERY SYSTEMS AND METHODS FOR MAKING THE SAME

(71) Applicant: GM GLOBAL TECHNOLOGY OPERATIONS LLC, Detroit, MI (US)

(72) Inventors: Zhe Li, Shanghai (CN); Zhongyi Liu, Troy, MI (US); Qili Su, Shanghai (CN); Haijing Liu, Shanghai (CN); Ratandeep S. Kukreja, Auburn Hills, MI (US)

(73) Assignee: GM GLOBAL TECHNOLOGY OPERATIONS LLC, Detroit, MI (US)

(21) Appl. No.: 18/783,630

(22) Filed: Jul. 25, 2024

(30) Foreign Application Priority Data
May 28, 2024 (CN) 202410674794.3

(51) Int. Cl. H01M 4/36; C01B 35/04; C01G 33/00; H01M 4/02; H01M 4/131; H01M 4/525; H01M 4/62; H01M 10/0562; H01M 10/0585; H01M 10/42

(52) U.S. Cl. CPC H01M 4/366; C01B 35/04; C01G 33/00; H01M 4/131; H01M 4/525; H01M 4/62; H01M 10/0562; H01M 10/0585; H01M 10/4235; C01P 2006/40; H01M 2004/028; H01M 2220/20; H01M 2300/0068

(57) ABSTRACT

A solid-state battery system includes a cathode that includes a coated cathode active material. The coated cathode active material includes a cathode active material, lithium niobate overlying the cathode active material, and titanium diboride overlying the cathode active material. The solid-state battery system further includes an anode and a solid electrolyte that is disposed between the cathode and the anode. The solid electrolyte is operable to provide lithium-ion conduction paths between the cathode and the anode.

### CROSS-REFERENCE TO RELATED APPLICATIONS

This application claims the benefit of priority to Chinese Patent Application CN202410674794.3 filed on May 28, 2024, which is hereby incorporated by reference in its entirety.

### Introduction

The disclosure generally relates to a solid-state battery system including a cathode that includes a coated cathode active material.

Battery cells may include an anode, a cathode, and an electrolyte. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A solid-state battery cell includes a solid electrolyte layer or film which provides lithium-ion conduction paths between the anode and the cathode. The solid electrolyte is a solid ionic conductor. The solid electrolyte is additionally an electronically insulating material. Particles of the solid electrolyte material may additionally be mixed or blended with materials of both the solid anode active particle and the solid cathode active particle.

### SUMMARY

A solid solid-state battery system, a method for making a solid-state battery system, and a vehicle including a solid-state battery system in accordance with one or more embodiments are provided. The solid-state battery system includes a cathode that includes a coated cathode active material. The coated cathode active material includes a cathode active material, lithium niobate overlying the cathode active material, and titanium diboride overlying the cathode active material. The solid-state battery system further includes an anode and a solid electrolyte. The solid electrolyte is disposed between the cathode and the anode and is operable to provide lithium-ion conduction paths between the cathode and the anode.

In some embodiments, titanium diboride is present in an amount of from about 0.1 to about 20 wt. % based on a total weight of the coated cathode active material.

In some embodiments, titanium diboride overlies from about 20 to about 100% of an outer surface of the cathode active material.

In some embodiments, lithium niobate is present in an amount of from about 0.1 to about 20 wt. % based on a total weight of the coated cathode active material.

In some embodiments, lithium niobate overlies from about 20 to about 100% of an outer surface of the cathode active material.

In some embodiments, the cathode active material is a nickel (Ni) based cathode active material.

In some embodiments, the cathode active material includes an electrochemically active material chosen from LiCoO₂, LiNiₓMn_{y}Co_{1-x-y}O₂, LiNiₓMn_{y}Al_{1-x-y}O₂, LiNiₓMn₁₋ₓO₂, Li₁₊ₓMnO₂, LiMn₂O₄, LiNi_{0.5}Mn_{1.5}O₄, LiV₂(PO₄)₃, LiFePO₄, LiMnₓFe₁₋ₓPO₄, or a combination(s) thereof.

In some embodiments, the cathode includes, based on a total weight of the cathode, a sulfide solid electrolyte present in an amount of from about 0 to about 50 wt. %, the coated cathode active material present in an amount of from about 30 to about 98 wt. %, a conductive additive present in an amount of from about 0 to about 30 wt. %, and a binder present in an amount of from about 0 to about 20 wt. %.

In some embodiments, the sulfide solid electrolyte includes an electrolyte chosen from a pseudo binary sulfide system, a pseudo ternary sulfide system, a pseudo quaternary sulfide system, or a combination(s) thereof.

In some embodiments, the conductive additive includes an electrically conductive material chosen from carbon black, graphite, graphene, graphene oxide, acetylene black, carbon nano fibers, carbon nanotubes, or a combination(s) thereof.

In some embodiments, the binder is chosen from polytetrafluoroethylene, sodium carboxymethyl cellulose, styrene-butadiene rubber, polyvinylidene fluoride, nitrile-butadiene rubber, styrene-ethylene-butylene-styrene copolymers, polyvinylidene fluoride-hexafluoro polyethylene, polyethylene oxide, polyacrylonitrile, poly(acrylic acid), styrene butadiene styrene copolymers, or a combination(s) thereof.

In some embodiments, the solid electrolyte forms a solid electrolyte layer that is disposed between the cathode and the anode. The solid electrolyte layer includes, by a total weight of the solid electrolyte layer, an electrolyte present in an amount of from about 20 to about 100 wt. %, fillers present in an amount of from about 0 to about 30 wt. %, and a binder present in an amount of from about 0 to about 20 wt. %.

In some embodiments, the electrolyte is chosen from a pseudo binary sulfide system, a pseudo ternary sulfide system, a pseudo quaternary sulfide system, or a combination(s) thereof.

In some embodiments, the fillers are chosen from oxide particles, polymeric fillers, lithium salts, or a combination(s) thereof.

In some embodiments, the binder is chosen from polyvinylidene fluoride, polyvinylidene fluoride-co-hexafluoropolypropylene, polytetrafluoroethylene, sodium carboxymethyl cellulose, styrene-butadiene rubber, nitrile butadiene rubber, styrene ethylene butylene styrene copolymers, polyethylene oxide, polyvinylpyrrolidone, polyvinyl alcohol, poly (acrylic acid), or a combination(s) thereof.

In some embodiments, the solid electrolyte layer has a thickness of from about 5 to about 200 μm.

A method for making a solid-state battery system in accordance with one or more embodiments includes forming a cathode. Forming the cathode includes providing a cathode active material, forming lithium niobate overlying the cathode active material, and forming titanium diboride overlying the cathode active material. The method further includes providing an anode. A solid electrolyte is disposed between the cathode and the anode. The solid electrolyte is operable to provide lithium-ion conduction paths between the cathode and the anode.

In some embodiments, forming lithium niobate includes forming lithium niobate overlying the cathode active material using a wet chemical-sintering process, an evaporation-drying process, or a mechanical fusion process.

In some embodiments, forming titanium diboride includes forming titanium diboride overlying the cathode active material using a wet chemical-sintering process, an evaporation-drying process, or a mechanical fusion process.

A vehicle in accordance with one or more embodiments includes an output device and a solid-state battery system configured to provide electrical energy to the output device. The solid-state battery system includes a cathode including a coated cathode active material. The coated cathode active material includes a cathode active material, lithium niobate overlying the cathode active material, and titanium diboride overlying the cathode active material. Lithium niobate is present in an amount of from about 0.1 to about 20 wt. % based on a total weight of the coated cathode active material. Titanium diboride is present in an amount of from about 0.1 to about 20 wt. % based on a total weight of the coated cathode active material. The solid-state battery system further includes an anode and a solid electrolyte. The solid electrolyte is disposed between the cathode and the anode and is operable to provide lithium-ion conduction paths between the cathode and the anode.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 illustrates a schematic view of a vehicle that includes a solid-state battery system and an output device in accordance with an exemplary embodiment.

FIG. 2 schematically illustrates, in cross sectional view, a portion of a battery system that includes a cathode, an anode, and a solid electrolyte that is disposed between the cathode and the anode in accordance with the present disclosure.

FIG. 3 is a graph illustrating exemplary test results of a relationship between voltage and capacity at 0.1 C initial formation for a battery cell that includes a cathode active material that has been coated with lithium niobate and titanium diboride versus a battery cell that includes a cathode active material that has been coated with lithium niobate, in accordance with the present disclosure.

FIG. 4 is a graph illustrating exemplary test results of a relationship between voltage and capacity at 0.5 C at the 50th cycle for a battery cell that includes a cathode active material that has been coated with lithium niobate and titanium diboride versus a battery cell that includes a cathode active material that has been coated with lithium niobate, in accordance with the present disclosure.

FIG. 5 is a graph illustrating exemplary test results of a relationship between discharge capacity and number of cycles at 0.5 C/0.5 C Cycling for a battery cell that includes a cathode active material that has been coated with lithium niobate and titanium diboride versus a battery cell that includes a cathode active material that has been coated with lithium niobate, in accordance with the present disclosure.

FIG. 6 schematically illustrates a method for making a solid-state battery system in accordance with the present disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

Referring to the drawings, like reference numerals correspond to like or similar components throughout the several figures.

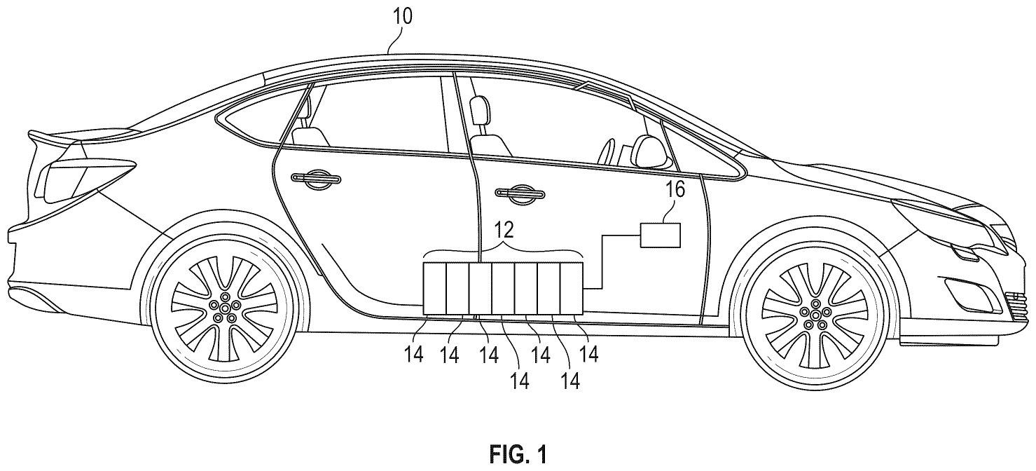

FIG. 1 schematically illustrates an exemplary device 10, e.g., a battery electric vehicle (BEV), including a battery pack 12 that includes a plurality of battery cells 14. Although the battery cells 14 are illustrated as being utilized in a BEV, it is to be understood that the battery cells 14 may be utilized in a wide range of applications and powertrains. The plurality of battery cells 14 may be connected in various combinations, for example, with a portion being connected in parallel and a portion being connected in series, to achieve goals of supplying electrical energy at a desired voltage. The battery pack 12 is illustrated as electrically connected to a motor generator unit 16 (e.g., output device) useful to provide motive force to the vehicle 10. The motor generator unit 16 may include an output component, for example, an output shaft, which is provided mechanical energy useful to provide the motive force to the vehicle 10. A number of variations to vehicle 10 are envisioned, and the disclosure is not intended to be limited to the examples provided.

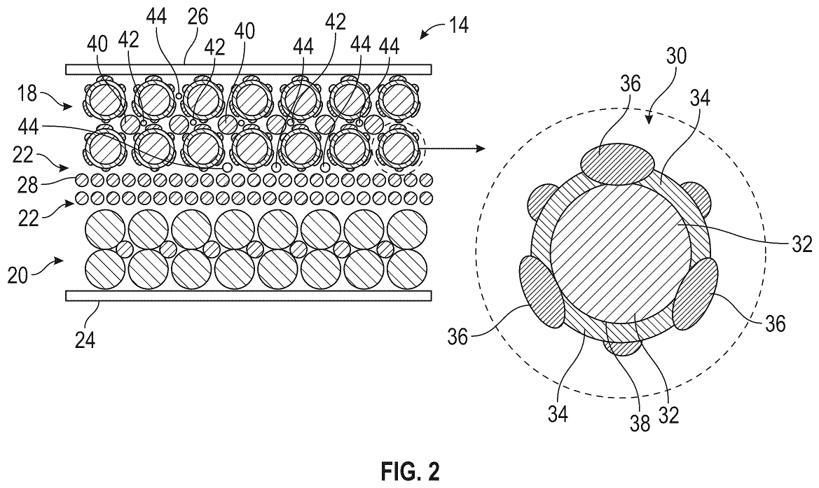

FIG. 2 schematically illustrates, in cross sectional view, a portion of an exemplary battery cell 14 of the battery pack 12. The battery cell 14 includes a cathode 18, an anode 20, and a solid electrolyte 22 that is disposed between the cathode 18 and the anode 20 in accordance with an exemplary embodiment. The battery cell 14 enables converting electrical energy into stored chemical energy in a charging cycle, and the battery cell 14 enables converting stored chemical energy into electrical energy in a discharging cycle. A negative current collector 24 is illustrated connected to the anode 20, and a positive current collector 26 is illustrated connected to the cathode 18. The solid electrolyte 22 provides a lithium-ion conduction path between the cathode 18 and the anode 20.

As illustrated, the cathode 18 includes a coated (e.g., dual-coated) cathode active material 30. The coated cathode active material 30 includes a cathode active material 32, lithium niobate (LiNbO₃) 34 overlying the cathode active material 32, and titanium diboride (TiB₂) 36 overlying the cathode active material 32.

In an exemplary embodiment, titanium diboride 36 is present in an amount of from about 0.1 to about 20 wt. %, such as from about 2 to about 18 wt. %, such as from about 3 to about 10 wt. %, for example from about 4 to about 6 wt. %, based on a total weight of the coated cathode active material 30. In an exemplary embodiment, titanium diboride overlies from about 20 to about 100%, such as from about 40 to about 80%, for example from about 50 to about 70%, of an outer surface 38 of the cathode active material 32.

In an exemplary embodiment, lithium niobate 34 is present in an amount of from about 0.1 to about 20 wt. %, such as from about 0.2 to about 10 wt. %, such as from about 0.5 to about 5 wt. %, such as about from 0.7 to about 2 wt. %, for example from about 0.9 to about 1.1 wt. %, based on a total weight of the coated cathode active material 30. In an exemplary embodiment, lithium niobate 34 overlies from about 20 to about 100%, such as from about 40 to about 80%, for example from about 50 to about 70%, of an outer surface 38 of the cathode active material 32.

In an exemplary embodiment, the cathode active material 32 is a metal oxide material that contains, among other metals, lithium for an electrochemical exchange of lithium ions and electrons between the anode 20 and the cathode 18 during operation (e.g., charging or discharging) of the battery cell 14. In an exemplary embodiment, the cathode active material 32 includes an electrochemically active material chosen from LiCoO₂, LiNiₓMn_{y}Co_{1-x-y}O₂, LiNiₓMn_{y}Al_{1-x-y}O₂, LiNiₓMn₁₋ₓO₂, Li₁₊ₓMnO₂, LiMn₂O₄, LiNi_{0.5}Mn_{1.5}O₄, LiV₂(PO₄)₃, LiFePO₄, LiMnₓFe₁₋ₓPO₄, or a combination(s) thereof. In an exemplary embodiment, the cathode active material 32 is a nickel (Ni) based cathode active material, such as, for example, LiNiₓMn_{y}Co_{1-x-y}O₂, LiNiₓMn_{y}Al_{1-x-y}O₂, LiNiₓMn₁₋ₓO₂, or LiNi_{0.5}Mn_{1.5}O₄, wherein X is a value from 0.3 to 0.99 (e.g., 0.3<X<0.99) and Y is a value from 0.1 to 0.99 (e.g., 0.1<Y<0.99). Other metal oxides for the cathode active material 32 that promote the electrochemical exchange of lithium ions and electrons between the anode 20 and the cathode 18 may also be used.

In an exemplary embodiment, the cathode 18 includes, based on a total weight of the cathode 18, a sulfide solid electrolyte 40 present in an amount of from about 0 to about 50 wt. %. The cathode 18 further includes, based on the total weight of the cathode 18, the coated cathode active material 30 present in an amount of from about 30 to about 98 wt. %, a conductive additive 42 present in an amount of from about 0 to about 30 wt. %, and a binder 44 present in an amount of from about 0 to about 20 wt. %.

In an exemplary embodiment, the sulfide solid electrolyte 40 includes an electrolyte chosen from a pseudo binary sulfide system, a pseudo ternary sulfide system, a pseudo quaternary sulfide system, or a combination(s) thereof. Non-limiting examples of a pseudo binary sulfide system include Li₂S—P₂S₅ system (Li₃PS₄, Li₇P₃S₁₁, and Li_{9.6}P₃S₁₂), Li₂S—SnS₂ system (Li₄SnS₄), Li₂S—SiS₂ system, Li₂—GeS₂ system, Li₂S—B₂S₃ system, Li₂S—Ga₂S₃ system, Li₂S—P₂S₃ system, and Li₂S—Al₂S₃ system. Non-limiting examples of a pseudo ternary sulfide system include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, or I) system (Li₆PS₅Br, Li₆PS₅Cl, Li₆PS₅Cl_{0.5}Br_{0.5}, Li₇P₂S₈I and Li₄PS₄I), Li₂S—As₂S₅—SnS2 system (Li_{3.833}Sn_{0.833}As_{0.166}S4), Li₂S—P₂S₅—Al₂S₃ system, Li₂S—LiX—SiS₂ (X=F, Cl, Br, or I) system, 0.4LiI-0.6Li₄SnS₄, and Li₁₁Si₂PS₁₂. Non-limiting examples of a pseudo quaternary sulfide system include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In an exemplary embodiment, the conductive additive 42 includes an electrically conductive material chosen from carbon black, graphite, graphene, graphene oxide, acetylene black, carbon nano fibers, carbon nanotubes, or a combination(s) thereof. In an exemplary embodiment, the binder 44 is chosen from polytetrafluoroethylene, sodium carboxymethyl cellulose, styrene-butadiene rubber, polyvinylidene fluoride, nitrile-butadiene rubber, styrene-ethylene-butylene-styrene copolymers, polyvinylidene fluoride-hexafluoro polyethylene, polyethylene oxide, polyacrylonitrile, poly(acrylic acid), styrene butadiene styrene copolymers, or a combination(s) thereof.

As illustrated in FIG. 2, the solid electrolyte 22 is configured as a solid electrolyte layer 28 that is sandwiched between the cathode 18 and the anode 20. In an exemplary embodiment, the solid electrolyte layer 28 has a thickness of from about 5 to about 200 μm. In an exemplary embodiment, the solid electrolyte layer 28 includes or consists of, by a total weight of the solid electrolyte layer 28, an electrolyte (e.g., in solid form) present in an amount of from about 20 to about 100 wt. %, fillers present in an amount of from about 0 to about 30 wt. %, and a binder present in an amount of from about 0 to about 20 wt. %.

In an exemplary embodiment, the electrolyte for the solid electrolyte layer 28 is chosen from a pseudo binary sulfide system, a pseudo ternary sulfide system, a pseudo quaternary sulfide system, or a combination(s) thereof. Examples of such sulfide electrolyte systems are provided above in the foregoing paragraphs in relation to the sulfide solid electrolyte 40.

In an exemplary embodiment, the fillers for the solid electrolyte layer 28 are chosen from oxide particles, polymeric fillers, lithium salts, or a combination(s) thereof. In an exemplary embodiment, the binder for the solid electrolyte layer 28 is chosen from polyvinylidene fluoride, polyvinylidene fluoride-co-hexafluoropolypropylene, polytetrafluoroethylene, sodium carboxymethyl cellulose, styrene-butadiene rubber, nitrile butadiene rubber, styrene ethylene butylene styrene copolymers, polyethylene oxide, polyvinylpyrrolidone, polyvinyl alcohol, poly (acrylic acid), or the like, or a combination(s) thereof.

As illustrated and discussed above, the battery cell 14 includes the anode 20. In some embodiments, the anode 20 is configured as an anode layer having a thickness of from about 10 to about 400 μm and includes lithium metal or lithium alloy, e.g., Li—In alloy. In an exemplary embodiment, the anode layer includes an anode active material present in an amount of from about 30 to about 98 wt. %, a solid electrolyte present in an amount of from about 0 to about 50 wt. %, a conductive additive(s) present in an amount of from about 0 to about 30 wt. %, and a binder present in an amount of from about 0 to about 20 wt. %.

Non-limiting examples of the anode active material include carbonaceous material, e.g., graphite, hard carbon, soft carbon, or the like, silicon, silicon mixed with graphite, Li₄Ti₅O₁₂, transition-metal, e.g., Sn, metal oxide/sulfide, e.g., TiO₂, FeS, or the like. Alternatively, other lithium-accepting anode materials may also be used.

In an exemplary embodiment, the solid electrolyte for the anode 20 is chosen from a pseudo binary sulfide system, a pseudo ternary sulfide system, a pseudo quaternary sulfide system, or a combination(s) thereof. Examples of such sulfide electrolyte systems are provided above in the foregoing paragraphs in relation to the sulfide solid electrolyte 40.

Non-limiting examples of the conductive additives for the anode 20 include carbon black, graphite, graphene, graphene oxide, acetylene black, carbon nano fibers, carbon nanotubes, and/or other electrically conductive additives. Non-limiting examples of the binder include polyvinylidene fluoride, polyvinylidene fluoride-co-hexafluoropolypropylene, polytetrafluoroethylene, sodium carboxymethyl cellulose, styrene-butadiene rubber, nitrile butadiene rubber, styrene ethylene butylene styrene copolymers, polyethylene oxide, polyvinylpyrrolidone, polyvinyl alcohol, poly(acrylic acid), or the like, or a combination(s) thereof.

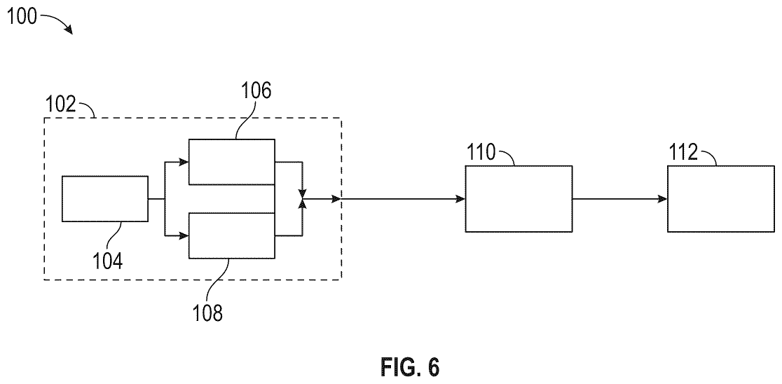

Referring to FIG. 6, a method 100 for making a solid-state battery system in accordance with an exemplary embodiment is provided. The method 100 includes forming a cathode (STEP 102) as discussed above in reference to FIG. 2. The cathode is formed by providing (STEP 104) a cathode active material.

The method 100 includes forming (STEP 106) lithium niobate overlying the cathode active material. In one example, lithium niobate is formed by using a wet chemical-sintering process. The wet chemical-sintering process includes forming a lithium niobate precursor solution containing lithium ethoxide, ethanol, and niobium ethoxide mixed according to a stoichiometric ratio of lithium niobate. The remaining cathode materials as discussed above are added into the precursor solution and mixed. The solution amount will determine the coating ratio, e.g. about 1 wt. %. Next, the solution is sintered at a temperature of from about 350 to about 500° C. for a time of from about 1 to about 5 hours to form the lithium niobate coating overlying the cathode active material. Alternatively, lithium niobate may be formed by an evaporation-drying process or a mechanical fusion process using, for example, using lithium niobate as a raw material for fusing to the cathode active material.

The method 100 includes forming (STEP 108) titanium diboride overlying the cathode active material. In one example, titanium diboride is formed by using an evaporation-drying process. The evaporation-drying process includes dispersing titanium diboride nanoparticles e.g., average particle size of about 50 nm, in ethanol to form a solution in which the amount of titanium diboride nanoparticles and ethanol solvent will determine the coating ratio, e.g., 5 wt. %. The solution is either applied to or has incorporated therein the cathode active material, which may have already been pretreated with the lithium niobate, or alternatively, with neat cathode active material in the event that STEP 108 precedes STEP 106. The solution is then dried including evaporation of the ethanol solvent to ensure a homogeneous coating on the surface of the cathode active material. In one example, the solution is dried at a temperature of from about 70 to about 150° C., for example about 100° C., for a time of from about 2 to about 12 hours, for example about 4 hours, in air. Alternatively, titanium diboride may be formed by a wet chemical-sintering process or a mechanical fusion process using, for example, titanium diboride as a raw material for fusing to the cathode active material.

The method 100 continues by providing (STEP 110) an anode as described above in the foregoing. A solid electrolyte (e.g., 22, 28 shown in FIG. 2) as discussed above in the foregoing is disposed (STEP 112) between the cathode and the anode. The solid electrolyte is operable to provide lithium-ion conduction paths between the cathode and the anode.

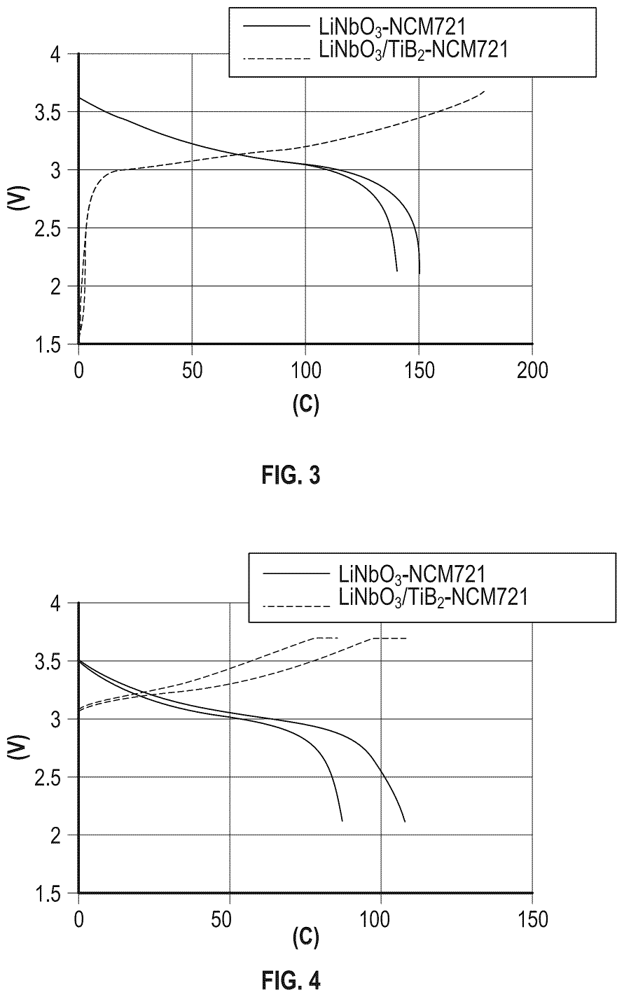

FIG. 3 is a graph illustrating exemplary test results of a relationship between voltage and capacity at 0.1 C initial formation for a battery cell that includes a cathode active material (e.g., NCM721—LiNi_{0.7}Co_{0.2}Mn_{0.1}) that has been coated with lithium niobate and titanium diboride versus a battery cell that includes a cathode active material that has been coated with lithium niobate, in accordance with the present disclosure. The X-axis represents Capacity (C) in mAh/g and the Y-axis represents Voltage (V). As illustrated, the cathode active material that has been coated with lithium niobate and titanium diboride delivers an enhanced lithium capacity at 0.1 C when compared with the cathode active material that has been coated with lithium niobate. This results from results from the enhanced electronic conduction of the electrode due to the coated titanium diboride.

FIG. 4 is a graph illustrating exemplary test results of a relationship between voltage and capacity at 0.5 C at the 50th cycle for a battery cell that includes a cathode active material (e.g., NCM721—LiNi_{0.7}Co_{0.2}Mn_{0.1}) that has been coated with lithium niobate and titanium diboride versus a battery cell that includes a cathode active material that has been coated with lithium niobate, in accordance with the present disclosure. The X-axis represents Capacity (C) in mAh/g and the Y-axis represents Voltage (V). As illustrated, the cathode active material that has been coated with lithium niobate and titanium diboride can deliver an enhanced lithium capacity at 0.5 C when compared with the cathode active material that has been coated with lithium niobate. Again, this results from the enhanced electronic conduction of the electrode due to the coated titanium diboride.

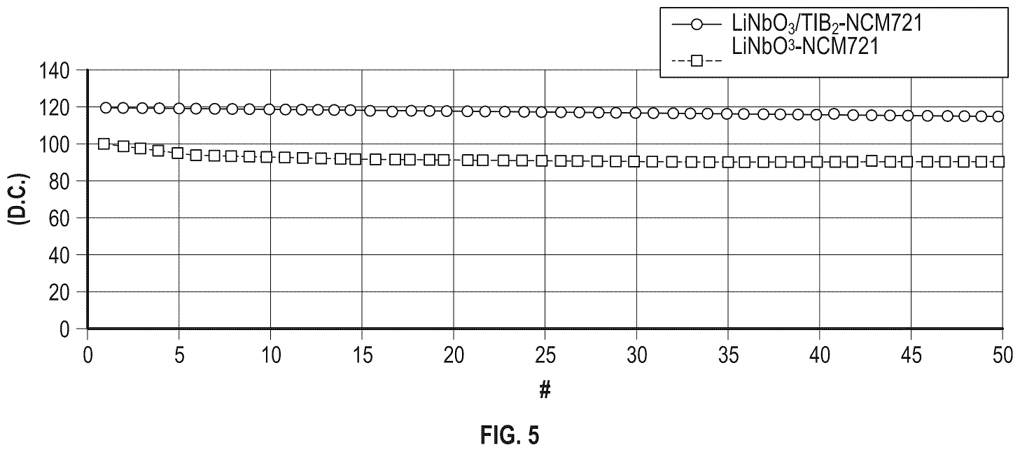

FIG. 5 is a graph illustrating exemplary test results of a relationship between discharge capacity and number of cycles at 0.5 C/0.5 C Cycling for a battery cell that includes a cathode active material (e.g., NCM721—LiNi_{0.7}Co_{0.2}Mn_{0.1}) that has been coated with lithium niobate and titanium diboride versus a battery cell that includes a cathode active material that has been coated with lithium niobate, in accordance with the present disclosure. The X-axis represents cycle number (#) and the Y-axis represents Discharge Capacity in mAh/g. As illustrated, the cathode active material that has been coated with lithium niobate and titanium diboride can deliver a good cell cycling with enhanced lithium capacity when compared with the cathode active material that has been coated with lithium niobate. Yet again, this results from the enhanced electronic conduction of the electrode due to the coated titanium diboride.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A solid-state battery system comprising:
a cathode comprising a coated cathode active material, wherein the coated cathode active material comprises:
a cathode active material;
lithium niobate overlying the cathode active material; and
titanium diboride overlying the cathode active material;
an anode; and
a solid electrolyte disposed between the cathode and the anode and operable to provide lithium-ion conduction paths between the cathode and the anode.

2. The solid-state battery system of claim 1, wherein titanium diboride is present in an amount of from about 0.1 to about 20 wt. % based on a total weight of the coated cathode active material.

3. The solid-state battery system of claim 1, wherein titanium diboride overlies from about 20 to about 100% of an outer surface of the cathode active material.

4. The solid-state battery system of claim 1, wherein lithium niobate is present in an amount of from about 0.1 to about 20 wt. % based on a total weight of the coated cathode active material.

5. The solid-state battery system of claim 1, wherein lithium niobate overlies from about 20 to about 100% of an outer surface of the cathode active material.

6. The solid-state battery system of claim 1, wherein the cathode active material is a nickel (Ni) based cathode active material.

7. The solid-state battery system of claim 1, wherein the cathode active material comprises an electrochemically active material chosen from LiCoO₂, LiNiₓMn_{y}Co_{1-x-y}O₂, LiNiₓMn_{y}Al_{1-x-y}O₂, LiNiₓMn₁₋ₓO₂, Li₁₊ₓMnO₂, LiMn₂O₄, LiNi_{0.5}Mn_{1.5}O₄, LiV₂(PO₄)₃, LiFePO₄, LiMnₓFe₁₋ₓPO₄, or a combination(s) thereof.

8. The solid-state battery system of claim 1, wherein the cathode comprises, based on a total weight of the cathode, a sulfide solid electrolyte present in an amount of from about 0 to about 50 wt. %, the coated cathode active material present in an amount of from about 30 to about 98 wt. %, a conductive additive present in an amount of from about 0 to about 30 wt. %, and a binder present in an amount of from about 0 to about 20 wt. %.

9. The solid-state battery system of claim 8, wherein the sulfide solid electrolyte comprises an electrolyte chosen from a pseudo binary sulfide system, a pseudo ternary sulfide system, a pseudo quaternary sulfide system, or a combination(s) thereof.

10. The solid-state battery system of claim 8, wherein the conductive additive comprises an electrically conductive material chosen from carbon black, graphite, graphene, graphene oxide, acetylene black, carbon nano fibers, carbon nanotubes, or a combination(s) thereof.

11. The solid-state battery system of claim 8, wherein the binder is chosen from polytetrafluoroethylene, sodium carboxymethyl cellulose, styrene-butadiene rubber, polyvinylidene fluoride, nitrile-butadiene rubber, styrene-ethylene-butylene-styrene copolymers, polyvinylidene fluoride-hexafluoro polyethylene, polyethylene oxide, polyacrylonitrile, poly(acrylic acid), styrene butadiene styrene copolymers, or a combination(s) thereof.

12. The solid-state battery system of claim 1, wherein the solid electrolyte forms a solid electrolyte layer that is disposed between the cathode and the anode, and wherein the solid electrolyte layer comprises, by a total weight of the solid electrolyte layer, an electrolyte present in an amount of from about 20 to about 100 wt. %, fillers present in an amount of from about 0 to about 30 wt. %, and a binder present in an amount of from about 0 to about 20 wt. %.

13. The solid-state battery system of claim 12, wherein the electrolyte is chosen from a pseudo binary sulfide system, a pseudo ternary sulfide system, a pseudo quaternary sulfide system, or a combination(s) thereof.

14. The solid-state battery system of claim 12, wherein the fillers are chosen from oxide particles, polymeric fillers, lithium salts, or a combination(s) thereof.

15. The solid-state battery system of claim 12, wherein the binder is chosen from polyvinylidene fluoride, polyvinylidene fluoride-co-hexafluoropolypropylene, polytetrafluoroethylene, sodium carboxymethyl cellulose, styrene-butadiene rubber, nitrile butadiene rubber, styrene ethylene butylene styrene copolymers, polyethylene oxide, polyvinylpyrrolidone, polyvinyl alcohol, poly (acrylic acid), or a combination(s) thereof.

16. The solid-state battery system of claim 12, wherein the solid electrolyte layer has a thickness of from about 5 to about 200 μm.

17. A method for making a solid-state battery system, the method comprising:
forming a cathode comprising:
providing a cathode active material;
forming lithium niobate overlying the cathode active material; and
forming titanium diboride overlying the cathode active material;
providing an anode; and
disposing a solid electrolyte between the cathode and the anode, wherein the solid electrolyte is operable to provide lithium-ion conduction paths between the cathode and the anode.

18. The method of claim 17, wherein forming lithium niobate comprises forming lithium niobate overlying the cathode active material using a wet chemical-sintering process, an evaporation-drying process, or a mechanical fusion process.

19. The method of claim 17, wherein forming titanium diboride comprises forming titanium diboride overlying the cathode active material using a wet chemical-sintering process, an evaporation-drying process, or a mechanical fusion process.

20. A vehicle comprising:
an output device; and
a solid-state battery system configured to provide electrical energy to the output device, the solid-state battery system comprising:
a cathode comprising a coated cathode active material, wherein the coated cathode active material comprises:
a cathode active material;
lithium niobate overlying the cathode active material, wherein lithium niobate is present in an amount of from about 0.1 to about 20 wt. % based on a total weight of the coated cathode active material; and
titanium diboride overlying the cathode active material, wherein titanium diboride is present in an amount of from about 0.1 to about 20 wt. % based on a total weight of the coated cathode active material;
an anode; and
a solid electrolyte disposed between the cathode and the anode and operable to provide lithium-ion conduction paths between the cathode and the anode.
